(19) United States
(12) Patent Application Publication
(10) Pub. No.: US 2022/0253468 A1
(43) Pub. Date: Aug. 11, 2022

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventor: Naoya OKA, Nagakute-shi (JP)

(73) Assignee: TOYOTA JIDOSHA KABUSHIKI KAISHA, Toyota-shi (JP)

(21) Appl. No.: 17/456,031

(22) Filed: Nov. 22, 2021

(30) Foreign Application Priority Data
Feb. 10, 2021 (JP) 2021-020246

(51) Int. Cl. G06F 16/29; G06F 16/245; G01C 21/34

(52) U.S. Cl. CPC G06F 16/29; G01C 21/3415; G06F 16/245

(57) ABSTRACT

An information processing apparatus searches for a location of a specific facility specified by a user based on first information that is current geographical information including locations of a plurality of facilities. The information processing apparatus searches for the location of the specific facility based on second information that is geographical information including locations of a plurality of facilities and that is geographical information o it a time prior to a current time. The information processing apparatus generates result information based on a first result t tat is a search result based on the first information and a second result that is a search result based on the second information and notifies the user of the result information.

### CROSS-REFERENCE TO RELATED APPLICATION

This application claims priority to Japanese Patent Application No. 2021-020246 filed on Feb. 10, 2021, incorporated herein by reference in its entirety.

### BACKGROUND

### 1. Technical Field

The disclosure relates to an information processing apparatus, an information processing method, and a program.

### 2. Description of Related Art

Japanese Unexamined Patent Application Publication No. 2007-257270 (JP 2007-257270 A) describes an in-vehicle information search apparatus. The information search apparatus described in JP 2007-257270 A is an apparatus that performs information search from a database in which search target information is recorded. The information search apparatus identifies a search key associated with information to be updated among the search target information in the database based on predetermined historical information on information search. The information search apparatus updates search target information associated with the identified search key in the database by using update data for the search target information associated with the search key.

### SUMMARY

The disclosure is directed to improving the convenience of a user that searches for a facility.

A first aspect of the disclosure relates to an information processing apparatus. The information processing apparatus includes a control unit configured to search for a location of a specific facility specified by a user based on first information that is current geographical information including locations of a plurality of facilities, search for the location of the specific facility based on second information that is geographical information including locations of a plurality of facilities and that is geographical information at a time prior to a current time, and generate result information based on a first result that is a search result based on the first information and a second result that is a search result based on the second information and notify the user of the result information.

A second aspect of the disclosure relates to an information processing method that is executed by a computer. The information processing method includes searching for a location of a specific facility specified by a user based on first information that is current geographical information including locations of a plurality of facilities, searching for the location of the specific facility based on second information that is geographical information including locations of a plurality of facilities and that is geographical information at a time prior to a current time, and generating result information based on a first result that is a search result based on the first information and a second result that is a search result based on the second information and notifying the user of the result information.

A third aspect of the disclosure relates to a program for causing a computer to execute instructions. The instructions include receiving result information including a location of a specific facility specified by a user based on a search result that is based on first information that is current geographical information including locations of a plurality of facilities and that is on the location of the specific facility and a search result that is on a location of the specific facility based on second information including locations of a plurality of facilities at a time prior to a current time, and, based on the result information, displaying the location of the specific facility at the time and displaying information on the current location of the specific facility.

According to the disclosure, it is possible to improve the convenience of a user that searches for a facility.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the schematic configuration of a search system;

FIG. 2 is a block diagram schematically showing an example of the functional configuration of a user terminal and a search server;

FIG. 3 is a view showing a table configuration of multiple pieces of geographical information stored in a geographical information database according to a first embodiment;

FIG. 4 is a flowchart of a search process;

FIG. 5 is a flowchart of a sending process according to the first embodiment;

FIG. 6 is a view showing an example of a result screen displayed on an input/output unit of the user terminal;

FIG. 7 is a view showing an example of a result screen displayed on the input/output unit of the user terminal;

FIG. 8 is a flowchart of a sending process according to a first modification;

FIG. 9 is a view showing a table configuration of multiple pieces of geographical information stored in a geographical information database according to a second embodiment; and

FIG. 10 is a flowchart of a generation process.

### DETAILED DESCRIPTION OF EMBODIMENTS

An information processing apparatus according to a first aspect of the disclosure is an information processing apparatus that provides information including location of a facility to a user. A control unit m the information processing apparatus according to the first aspect of the disclosure searches for a location of a specific facility specified by the user based on first information. The first information is current geographical information including locations of a plurality of facilities. The control unit of the information processing apparatus searches for a location of the specific facility based on second information. The second information is geographical information including locations of a plurality of facilities at a time prior to a current time. The control unit generates result information based on a first result that is a search result based on the first information and a second result that is a search result based on the second information. The control unit notifies the user of the result information.

The user assumes searching for a location of a specific facility based on a past memory on the specific facility, past information on the specific facility, or the like. In this case, the user causes the information processing apparatus to search for the location of the specific facility. The information processing apparatus searches for the location of the specific facility based on current geographical information (first information) and geographical information at a time prior to a current time (second information). The user is notified of result information based on a first result and a second result. Thus, the user is able to obtain the location of the specific facility in the past. The user is also able to learn whether the specific facility is currently in existence. At this time, when the specific facility is currently in existence, the user is able to obtain the current location of the specific facility. In this way, it is possible to improve the convenience of a user that searches for a facility.

Hereinafter, specific embodiments of the disclosure will be described with reference to the accompanying drawings. The dimensions, materials, and shapes of components described in the present embodiments, the arrangement of the components, and the like do not intend to limit the technical scope of the disclosure to them unless otherwise specified.

### First Embodiment

### Outline of System

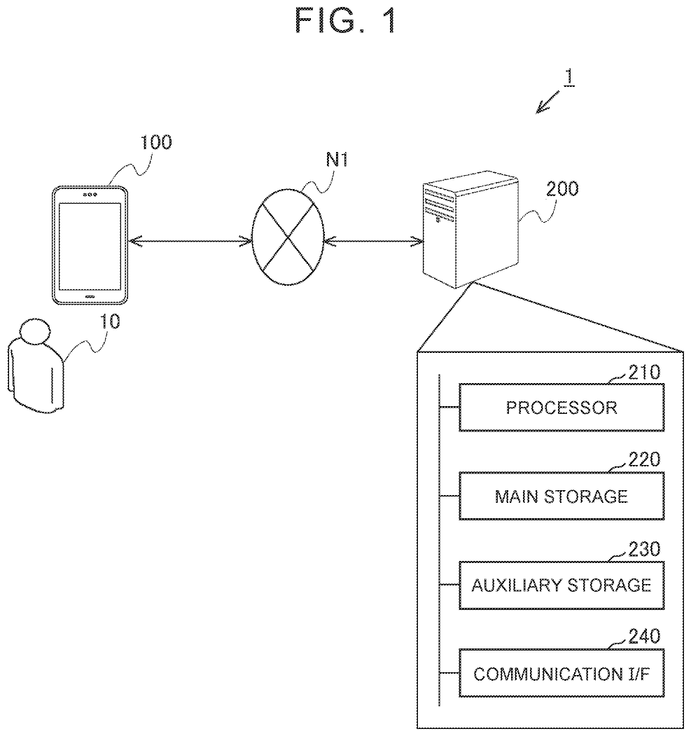

A search system 1 according to the present embodiment will be described with reference to FIG. 1. FIG. 1 is a diagram showing the schematic configuration of the search system 1. The search system 1 is made up of a user terminal 100 and a search server 200. In the search system 1, the user terminal 100 and the search server 200 are connected to each other by a network N1. A wide area network (WAN) that is a worldwide public telecommunication network, such as the Internet, or a telephone communication network, such as a mobile telephone network, may be employed as the network N1.

### Search Server

The search server 200 is a server that provides information including a location of a facility to a user 10. The search server 200 has multiple pieces of geographical information each including locations of a plurality of facilities. The multiple pieces of geographical information include current geographical information. In other words, the multiple pieces of geographical information include geographical information including current locations of a plurality of facilities. The multiple pieces of geographical information include geographical information at a time prior to the current geographical information. The search server 200 searches for a location of a facility specified by a user (hereinafter, which may be referred to as specific facility) based on the latest geographical information and geographical information at a time prior to the latest geographical information. At this time, the geographical information at the time prior to the latest geographical information is geographical information at a time specified by the user 10. The details of a method in which the search server 200 searches for the location of the specific facility based on the latest geographical information and geographical information at a time prior to the latest geographical information will be described later.

The search server 200 includes a computer including a processor 210, a main storage 220, an auxiliary storage 230, and a communication interface (communication I/F) 240. The processor 210 is, for example, a central processing unit (CPU) or a digital signal processor (DSP). The main storage 220 is, for example, a random access memory (RAM). The auxiliary storage 230 is, for example, a read only memory (ROM). The auxiliary storage 230 is also, for example, a hard disk drive (HDD) or a disk recording medium, such as a CD-ROM, a DVD, and a Blu-ray disc. The auxiliary storage 230 may be a removable medium (portable storage medium). For example, a USB flash drive or an SD card is illustrated as the removable medium. The communication I/F 240 is, for example, a local area network (LAN) interface board or a wireless communication circuit for wireless communication.

In the search server 200, an operating system (OS), various programs, various information tables, and the like are stored in the auxiliary storage 230. In the search server 200, the processor 210 is capable of implementing various functions as will be described later by loading the programs stored in the auxiliary storage 230 onto the main storage 220 and then running the loaded programs. One, some, or all of the functions in the search server 200 may be implemented by a hardware circuit, such as an ASIC and an FPGA. The search server 200 does not necessarily need to be implemented by a single physical component and may be made up of a plurality of computers that cooperate with each other.

### User Terminal

The user terminal 100 is a terminal associated with the user 10. The user terminal 100 is, for example, a terminal, such as a computer and a smartphone, used by the user 10. The user 10 searches for the location of a specific facility by using the user terminal 100. At this time, the user 10 searches for the location of the specific facility based on a past memory on the specific facility, past information on the specific facility, or the like.

In order to cause the search server 200 to search for the specific facility based on geographical information at a specified time, the user 10 operates the user terminal 100 to specify a time to search for the specific facility. Here, the user 10 determines a time to be specified (hereinafter, which may be referred to as specified time) based on, for example, a past memory on the specific facility. The user 10, for example, determines a time at which the specific facility was visited in the past as a specified time based on the past memory on the specific facility. The user 10, for example, estimates a time at which the user 10 visited the specific facility based on information, such as a record that the user 10 visited the specific facility m the past and determines the estimated time as a specified time for second geographical information. The user 10 inputs the specified time to the user terminal 100 and searches for the location of the specific facility. The user terminal 100 in the present embodiment may be regarded as the terminal according to the disclosure.

### Functional Configuration

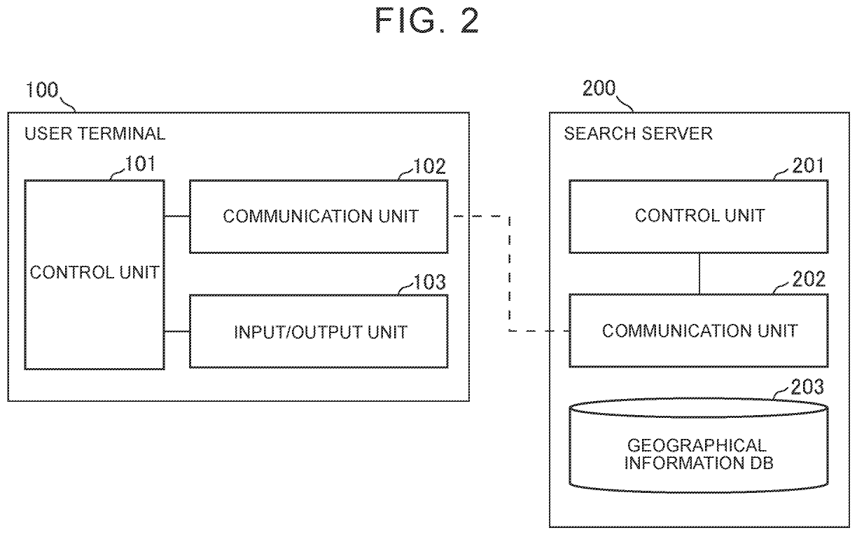

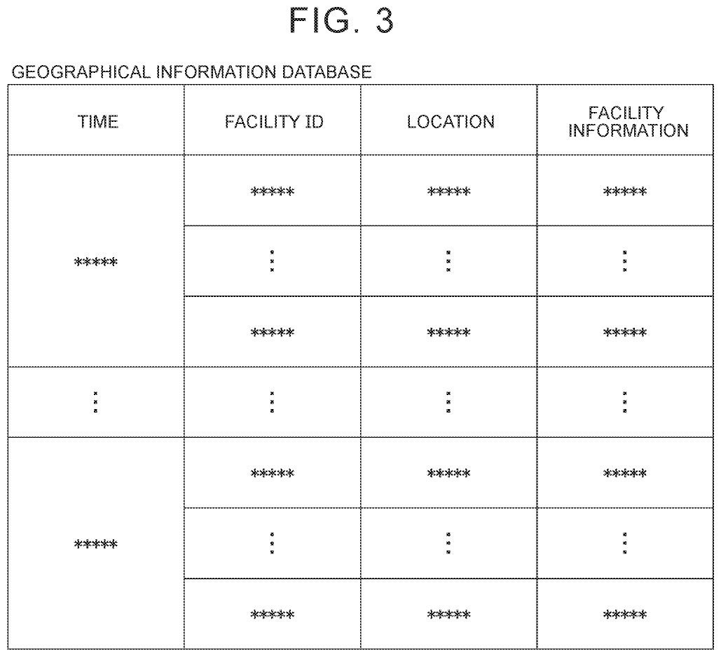

Next, the functional configuration of the user terminal 100 and the search server 200 that make up the search system 1 according to the present embodiment will be described with reference to FIG. 2 and FIG. 3. FIG. 2 is a block diagram schematically showing an example of the functional configuration of the user terminal 100 and the search server 200.

### User Terminal

The user terminal 100 includes a control unit 101, a communication unit 102, and an input/output unit 103. The control unit 101 has a function to perform arithmetic processing for controlling the user terminal 100. The control unit 101 may be implemented by a processor of the user terminal 100. The communication unit 102 has a function to connect the user terminal 100 to the network N1. The communication unit 102 may be implemented by a communication interface of the user terminal 100.

The input/output unit 103 has a function for the user 10 to input various pieces of information to the user terminal 100. The input/output unit 103 has a function to display various pieces of information for the user 10. The input/output unit 103 may be implemented by a touch panel of the user terminal 100. The user 10 inputs information for identifying a specific facility to the input/output unit 103 to search for the location of the specific facility. In the present embodiment, the user 10 inputs the facility name of a specific facility to the input/output unit 103 as information for identifying the specific facility. The user 10 inputs a specified time to the input/output unit 103. At this time, the user 10 may specify a range to search for the specific facility. The control unit 101 generates information including the facility name of the specific facility and the specified time (hereinafter, which may be referred to as search information), input to the input/output unit 103, as information for searching for the location of the specific facility. The control unit 101 sends the search information to the search server 200 via the communication unit 102.

The control unit 101 receives result information on the location of the specific facility from the search server 200 by the communication unit 102. When the control unit 101 receives result information, the control nun 101 displays the result information on the input/output unit 103. The details of the result information displayed on the input/output unit 103 will be described later.

### Search Server

The search server 200 includes a control unit 201, a communication unit 202, and a geographical information database 203 (geographical information DB 203). The control unit 201 has a function to perform arithmetic processing for controlling the search server 200. The control unit 201 may be implemented by a processor 210 of the search server 200. The communication unit 202 has a function to connect the search server 200 to the network N1. The communication unit 202 may be implemented by a communication I/F 240 of the search server 200.

The geographical information DB 203 is a database for storing historical information. The geographical information DB 203 may be implemented by the auxiliary storage 230 of the search server 200. FIG. 3 is a view showing a table configuration of multiple pieces of geographical information stored in the geographical information DB 203 according to the present embodiment. As shown in FIG. 3, pieces of geographical information at multiple times are stored in the geographical information DB 203. Geographical information at each time has a time field, a facility ID field, a location field, and a facility information field. Information indicating a time of each geographical information (time) is entered in the time field. An identifier for identifying a facility included in each piece of ,geographical information (facility ID) is entered in the facility ID field. Here, when the time of geographical information is different, a different facility ID can be entered in the facility ID field. In other words, geographical information reflects a change of a facility existing at a time of geographical information due to opening of a new facility or closure of a facility. Information indicating the location of a facility entered in the facility ID field is entered in the location field. Here, information indicating the location of a facility is, for example, the latitude and longitude of the facility. Information indicating a facility entered in the facility ID field is entered in the facility information field. Facility information is, for example, information on a commercial product, a service, or the like to be offered at a facility.

The control unit 201 receives search information from the user terminal 100 via the communication unit 202. The control unit 201 searches for the location of a specific facility based on the search information. Specifically, the control unit 201 searches for the location of a specific facility based on the facility name of the specific facility in the search information and current geographical information (hereinafter, which may be referred to as first information) among the multiple pieces of geographical information stored in the geographical information DB 203. In other words, the control unit 201 searches for the location of a specific facility by using the latest geographical information among the multiple pieces of geographical information stored in the geographical information DB 203 as first information. The control unit 201 acquires a search result (which may be referred to as first result) based on the first information.

Here, it is likely that no specific facility is included in the first information. In other words, it is likely that the specific facility is currently not in existence. In this case, the control unit 201 acquires information indicating that the specific facility is not in existence as a first result. When the specific facility is included in the tint information, the specific facility is currently in existence. The control unit 201 acquires the location of the specific facility in the first information as a first result.

The control unit 201 searches for the location of a specific facility based on the facility name of the specific facility in search information and geographical information at a specified time (hereinafter, which may be referred to as second information) among the multiple pieces of geographical information stored in the geographical information DB 203. The control unit 201 acquires a search result (which may be referred to as second result) based on the second information. Here, the second result is a result including the location of the specific facility in the second information. When the specific facility is included in the first information (the specific facility is currently in existence), the current location of the specific facility may be the same as the location of the specific facility at the specified time. In this case, the location of the specific facility in the first result and the location of the specific facility in the second result are the same location. There is a case where the specific facility is currently in existence hut the current location of the specific facility is different from the location of the specific facility at the specified time due to relocation or the like of the specific facility. In this case, the location of the specific facility in the first result is different from the location of the specific facility in the second result.

The control unit 201 generates result information based on the first result and the second result and sends the result information to the user terminal 100 via the communication unit 202. Here, when the specific facility is present in the first result, result information including the location of the specific facility in the first result and the location of the specific facility in the second result is sent to the user terminal 100.

When the specific facility is not present in the first result, the control unit 201 acquires facility information on a facility currently existing at the location of the specific facility in the second result (hereinafter, which may be referred to as currently existing facility) from the first information. In other words, the control unit 201 acquires facility information on the facility currently existing at the location where the specific facility had been in existence (the location of the specific facility in the second result). The control unit 201 sends the result information including the location of the specific facility in the second result and the facility information of the currently existing facility to the user terminal 100 via the communication unit 202.

### Search Process

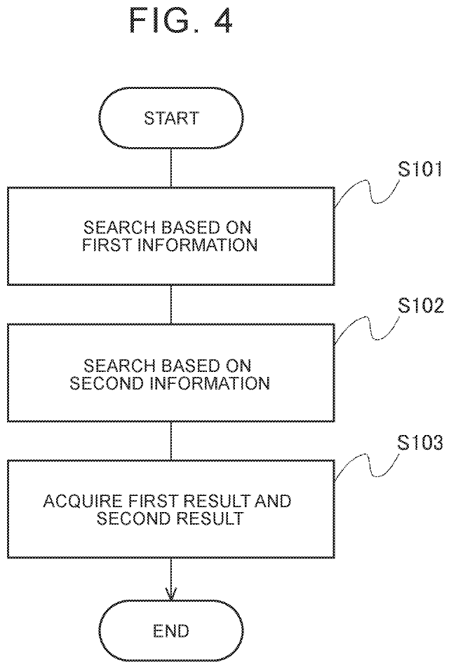

A search process that is executed by the control unit 201 in the search server 200 in the search system 1 will be described with reference to FIG. 4. FIG. 4 is a flowchart of the search process. The search process is a process of searching for a specific facility. The search process is executed when the search server 200 receives search information from the user terminal 100.

In the search process, in S101, the control unit 201 searches for the location of the specific facility based on first information. In S102, the control unit 201 searches for the location of the specific facility based on second information. Subsequently, in S103, the control unit 201 acquires a first result and a second result. Then, the control unit 201 ends the search process.

### Sending Process

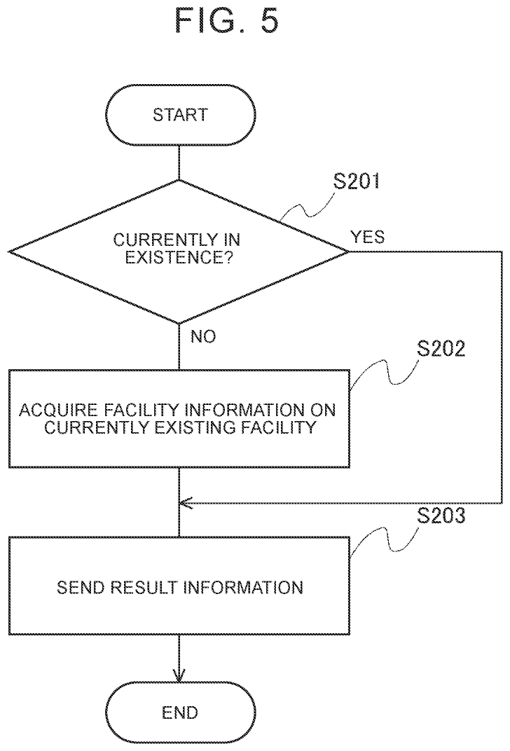

Next, a sending process thin is executed by the control unit 201 in the search server 200 in the search system 1 will be described with reference to FIG. 5. FIG. 5 is a flowchart of the sending process according to the present embodiment. The sending process according to the present embodiment is a process of sending result information to the user terminal 100. The sending process is executed when the search process is ended.

In the sending process, in S201, the control unit 201 determines whether the specific facility is present in the first result. In other words, in S201, the control unit 201 determines whether the specific facility is currently in existence. When the determination is affirmative in S201, the control unit 201 learns that the specific facility is currently in existence. In S203, the control unit 201 generates result information including the location of the specific facility in the first result and the location of the specific facility in the second result and sends the result information to the user terminal 100.

When the determination is negative in S201, the control unit 201 learns that the specific facility is not currently in existence. In S202, facility information on the currently existing facility is acquired from the first information stored in the geographical information DB 203 based on the first information. Subsequently, in S203, the control unit 201 generates result information including the location of the specific facility in the second result and the facility information on the currently existing facility and sends the result information to the user terminal 100. Then, the control unit 201 ends the sending process.

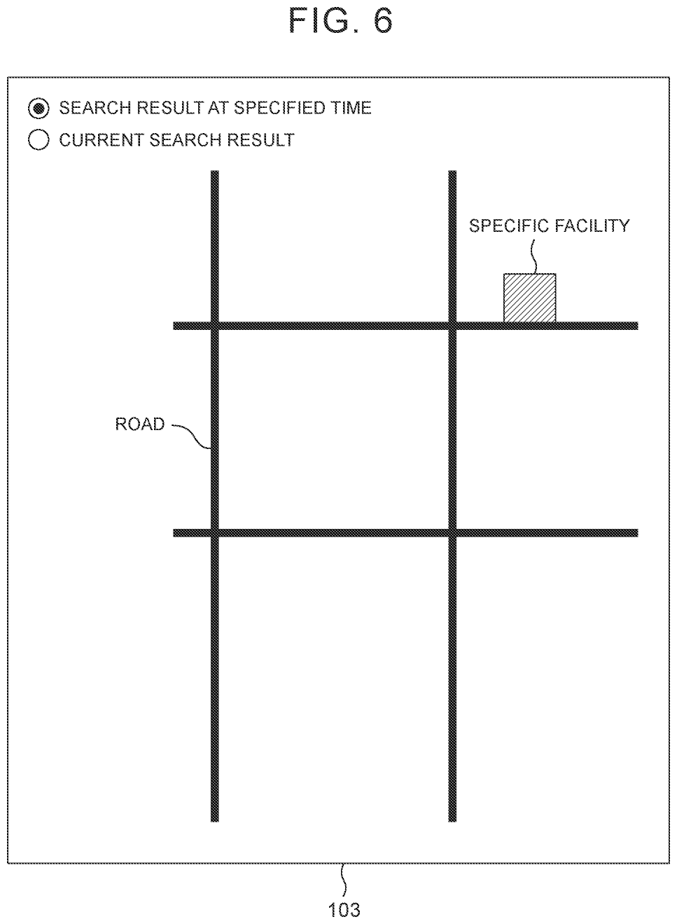

When the user terminal 100 receives the result information from the search server 200, the user terminal 100 displays a result screen on the input/output unit 103 of the user terminal 100. The result screen is a screen for displaying result information for the user 10. FIG. 6 is a view showing an example of the result screen displayed on the input/output unit 103 of the user terminal 100. As shown in FIG. 6, the location of the specific facility is displayed so as to be superposed on a map displayed on the input/output unit 103. Here, the map displayed on the result screen is a current map.

In the result screen, radio buttons for switching whether to display a search result at a specified time or to display a current search result are displayed. In the example shown in FIG. 6, display of a search result at a specified time is selected by the user 10. In this case, the location of the specific facility at the specified time (the location of the specific facility in the second result) is displayed on the current map. With this configuration, when the specific facility is currently not in existence, the user 10 is able to learn where the specific facility had been in existence on the current map.

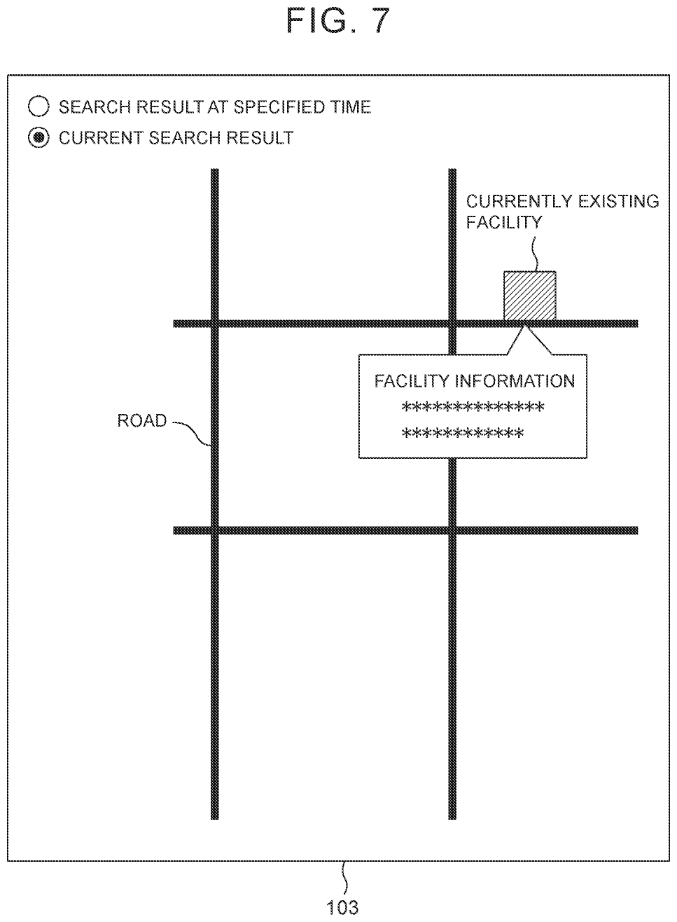

FIG. 7 is a view showing an example of the result screen displayed on the input/output unit 103 of the user terminal 100. In the example shown in FIG. 7, display of a current search result is selected by the user 10. When display of a current search result is selected, information an the current location of the specific facility is displayed on the input/output unit 103. FIG. 7 shows an example of display of the result screen in the case where the specific facility is not present in the first result. In this case, the facility information of the currently existing facility is displayed at a location where the specific facility had been in existence (the location of the specific facility in the second information) on the result screen. With this configuration, the user 10 is able to learn what kind of facility is currently existing at the location where the specific facility had been in existence at a specified time (in the past). When the specific facility is present in the first result, the location of the specific facility in the first result is displayed on a search screen.

As described above, the search server 200 searches for the location of the specific facility based on the first information and the second information. With this configuration, the user 10 is able to cause the search server 200 to search for the location of the specific facility based on the first information and the second information in accordance with a past memory on the specific facility, past information on the specific facility, or the like. With this configuration, in the case where the specific facility is currently in existence, the user 10 is able to learn the location of the specific facility (the location of the specific facility in the first result and the location of the specific facility in the second result). When the specific facility is currently not in existence as well, the user 10 is also able to learn the location at which the specific facility had been in existence at a specified time (in the past) and the facility information on the currently existing facility. In this way, in the search system 1, it is possible to improve the convenience of a user that searches for a facility.

### First Modification

In the first embodiment, when the specific facility is currently not in existence, the search server 200 sends the result information including the facility information on the currently existing facility to the user terminal 100. On the other hand, in the present modification, when the specific facility is currently not in existence, and when there is a facility of the same category as the specific facility (hereinafter, which may be referred to as similar facility) within a predetermined first range from the location of the specific facility, the search server 200 sends the facility information on the similar facility to the user terminal 100. Hereinafter, only the difference from the first embodiment will be described.

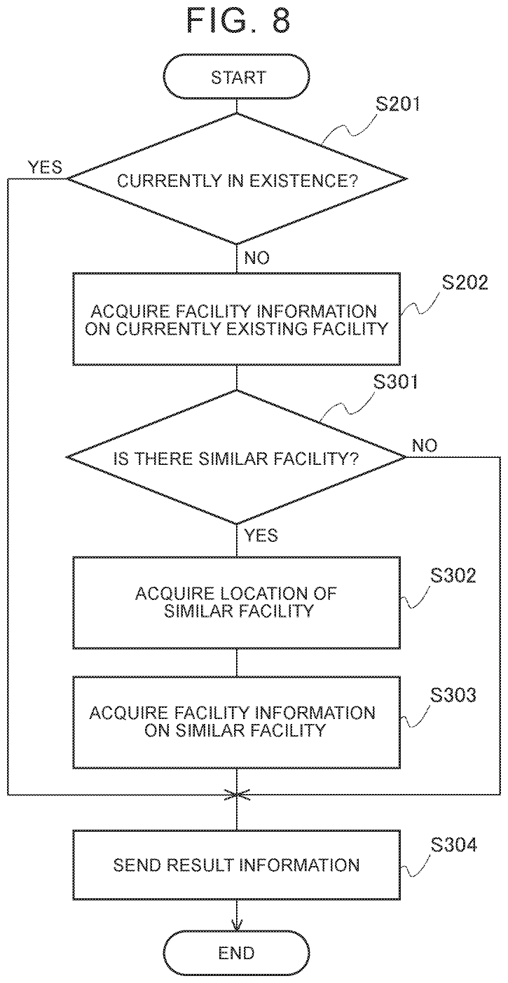

FIG. 8 is a flowchart of a sending process according to the present modification. In the sending process, when the determination is affirmative in S201, the control unit 201 sends the result information including the location of the specific facility to the user terminal 100 in S304.

When the determination is negative in S201 the control unit 201 executes the process of S202. Subsequently, in S301, the control unit 201 determines whether a similar facility is present within a predetermined first range from the location of the specific facility. The predetermined first range is, for example, a range specified by the user 10 or a range determined in advance. Specifically, the control unit 201 determines whether a similar facility is present within the predetermined first range based on the location of each facility and the facility information on each facility in the first information. When the determination is negative in S301, the control unit 201 learns that no similar facility is present within the predetermined first range. In S304, the control unit 201 sends result information including the location of the specific facility in the second result and the facility information on the currently existing facility to the user terminal 100. Then, the control unit 201 ends the sending process.

When the determination is affirmative in S301, the control unit 201 acquires the location of the similar facility from the first information in S302. In S303, the control unit 201 acquires the facility information on the similar facility from the first information. Subsequently, in S304, the control unit 201 generates result information including the location of the specific facility in the second result, the facility information on the currently existing facility, the location of the similar facility, and the facility information on the similar facility and sends the result information to the user terminal 100. Then, the control unit 701 ends the sending process.

It is assumed that the user terminal 100 receives the result information including the location of the similar facility and the facility information on the similar facility. At this time, when the current search result is selected on the result screen, the user terminal 100 displays the location of the similar facility and the facility information on the similar facility so as to be superposed on a map displayed on the input/output unit 103. With this configuration, the user 10 is able to learn not only the location of the specific facility in the second result and the facility information on the currently existing facility but also the location of the similar facility and the facility information on the similar facility. In other words, even when the specific facility is currently not in existence, the user 10 is able to learn the similar facility present within the predetermined first ranee. In this way as well, it is possible to improve the convenience of a user that searches for a facility.

### Second Modification

In the first embodiment, when the specific facility is currently not in existence, the search server 200 sends the result information including the facility information on the currently existing facility to the user terminal 100. When the specific facility is currently not in existence, the search server 200 may send result information including notification information for notifying that the specific facility is currently not in existence to the user terminal 100. In other words, the search server 200 may send the result information including the location of the specific facility in the second result, the facility information on the currently existing facility, and the notification information to the user terminal 100. In this case, when the user terminal 100 receives the result information, the user terminal 100 displays notification indicating that the specific facility is currently not in existence on the input/output unit 103. With this configuration, the user 10 is able to learn that the specific facility is currently not in existence.

### Third Modification

In the first embodiment, the search server 200 searches for the location of a specific facility based on geographical information at a specified time specified by the user 10. However, the search server 200 does not necessarily need to search for the location of a specific facility based on geographical information at a specified time specified by the user 10. The search server 200 may search for the location of a specific facility based on pieces of geographical information at multiple times. In this case, the search server 200 acquires search results based on pieces of geographical information at the multiple times as a second result. The search server 200 generates result information based on the first result and the second result. Here, it is assumed that, in the second result, there is a time at which the specific facility is not present. In this case, the search server 200 generates result information including the location of the specific facility and facility information on a facility present at the location at a time when the specific facility is not in existence. When the specific facility is not present in the first result, result information includes the facility information on the currently existing facility as in the case of the first embodiment.

When the user terminal 100 receives the result information, the user terminal 100 displays a result screen. At this time, the user terminal 100 displays a plurality of radio buttons for selecting display of a search result at each time. When display of a search result at a time when the specific facility is not in existence is selected on the result screen, the user terminal 100 displays the facility information on the facility existing at the location of the specific facility at the time. In this way, even when the user 10 does not specify a specified time, the user 10 is able to search for the location of a specific facility. With this configuration, even when the user 10 is not able to determine a time to search, the user 10 is able to search for a specific facility. As a result, it is possible to improve the convenience of a user that searches for a facility.

### Second Embodiment

In the present embodiment, the search server 200 searches for a route from the current location of the user 10 to the location of a specific facility (hereinafter, which may be referred to as destination) in second information. Hereinafter, only the difference from the first embodiment will be described. The search server 200 may search for a route from a location other than the current location of the user 10 to a destination. The search server 200 may, for example, search for a route from a departure point, which is a point specified by the user 10, to a destination.

### Search Server

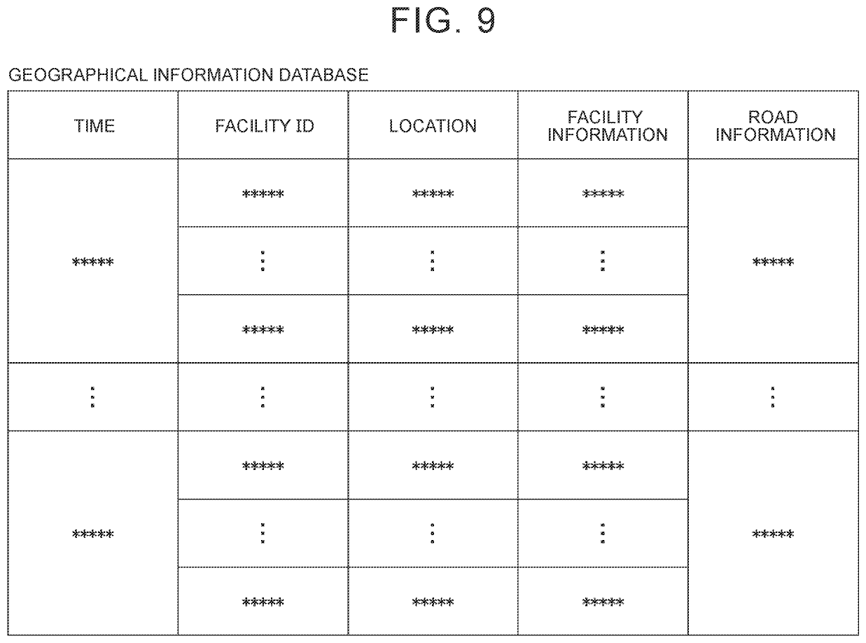

FIG. 9 is a view showing a table configuration of multiple pieces of geographical information stored in the geographical information DB 203 according to the present embodiment. Each of the pieces of geographical information further has a road information field. Information on the locations of roads at a time entered in the time field (typically, road map information; hereinafter, which may be referred to as road information) is entered in the road information field. Here, the locations of roads can vary depending on a time due to changes of the locations of roads, closure of roads, or the like. For this reason, road information at each time can vary among times. Facility information entered in the facility information field includes information on whether the facility becomes a landmark. Here, a landmark is an object that is a mark when the user moves. A landmark is, for example, an intersection or a structure that becomes a mark along a road.

The control unit 201 acquires the location of a specific facility from a second result. The control unit 201 receives the current location of the user 10 from the user terminal 100 through the communication unit 202. Here, the current location of the user 10 is acquired by a GPS receiver or the like in the user terminal 100. The control unit 201 venerates a route from the current location of the user 10 to a destination (hereinafter, which may be referred to as second route) based on road information in second information. The control unit 201 generates a route from the current location of the user 10 to a destination (hereinafter, which may be referred to as first route) based on the second route and the road information in first information and notifies the user 10 of the route.

Specifically, the control unit 201 acquires a point in the second route and at which a landmark is present within a predetermined second range (hereinafter, which may be referred to as landmark point) based on the facility information in the second information. Here, the predetermined second range is a range in which the user is able to visually recognise a landmark at a landmark point. The control unit 201 generates a first route such that the first route passes through the acquired landmark point. Here, the control unit 201 generates a first route based on road information in the first information. When a landmark is currently not in existence at the landmark point, the control unit 201 generates a first route such that the first route passes through a landmark point other than the landmark currently not in existence. The control unit 201 sends route information including the first route to the user terminal 100.

### Generation Process

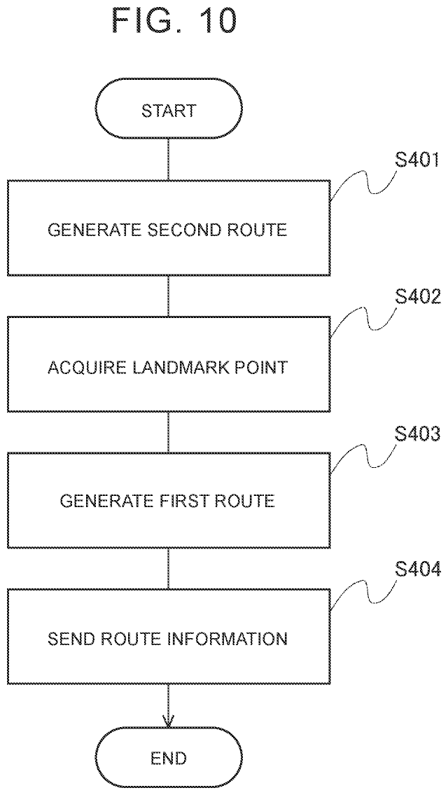

Next, a generation process that is executed by the control unit 201 in the search server 200 in the search system 1 will be described with reference to FIG. 10. FIG. 10 is a flowchart of the generation process. The generation process is a process of generating route information and sending the route information to the user terminal 100. The generation process is executed when the search process is ended.

In the generation process, initially, in S401, the control unit 201 generates a second route from the current location of the user 10 to a destination based on the road information in the second information. Subsequently, in S402, the control unit 201 acquires a landmark point in the second route. Subsequently, in S403, the control unit 201 generates a first route from the current location of the user 10 to the destination such that the first route passes through the acquired landmark point based on the road information in the first information. Subsequently, in S404, the control unit 201 sends route information including the first route to the user terminal 100. Then, the control unit 201 ends the generation process.

When the user terminal 100 receives the route information, the user terminal 100 displays the first route on a result screen. With this configuration, the user 10 is able to learn a moving route to the destination. Here, the first route is a route that passes through the landmark point. For this reason, the user 10 is able to pass through the landmark point when moving to the destination. Here, the landmark point is acquired based on the facility information in the second information, so the user 10 is able to move to the destination while recognizing a landmark that is likely to have been recognized when moving to the destination at a specified time. As a result, even when a road situation varies between a specified time and a current time, the user 10 is able to move to the destination as in the case when moving to the destination at the specified time. In this way, it is possible to improve the convenience of the user 10 that searches for a route to a specific facility.

### First Modification

In the present embodiment, the search server 200 generates a first route that passes through a landmark point. However, the search server 200 does not necessarily need to generate a first route such that the first route passes through a landmark point. The search server 200 may, for example, generate a first route based on a deviation from a second route. Specifically, the search server 200 generates a first route such that a deviation between the first route and a second route is minimum based on road information in first information. A known method may be employed as a method of generating a first route based on a deviation from a second route.

In this way, the search server 200 generates a first route based on a deviation from a second route. With this configuration, even when a road situation varies between a specified time and a current time, the user 10 is able to move to a destination by using a route (first route) smaller in deviation from a route (second route) when moving to the destination at a specified time. In this way as well, it is possible to improve the convenience of the user 10 that searches for a route to a specific facility.

### Other Embodiments

The above-described embodiments are only illustrative, and the disclosure can be implemented with modifications as needed without departing from the purport of the disclosure. The processes and devices described in this disclosure may be freely implemented in combination without any technical contradiction.

A process described as the one that is performed by a single apparatus may be shared and performed by a plurality of apparatuses. Alternatively, processes described as the ones that are respectively performed by different apparatuses may be performed by a single apparatus. In a computer system, what hardware configuration (server configuration) implements functions may be flexibly changed.

The disclosure may also be implemented as follows. A computer is supplied with a computer program having the functions described in the above-described embodiments, and one or more processors of the computer read out and run the program. Such a computer program may be provided to a computer with a non transitory computer-readable storage medium connectable to a system bus of the computer or may be provided to a computer via a network. Examples of the non-transitory computer-readable storage medium include a disk or disc of an type, such as a magnetic disk (floppy (registered trademark) disk, a hard disk drive (HDD), or the like), an optical disc (a CD-ROM, a DVD, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. An information processing apparatus comprising a control unit configured to
search for a location of a specific facility specified by a user based on first information that is current geographical information including location of a plurality of facilities,
search for the location of the specific facility based on second information that is geographical information including locations of a plurality of facilities and that is geographical information at a time prior to a current time, and
generate result information based on a first result that is a search result based on the first information and a second result that is a search result based on the second information and notify the user of the result information.

2. The information processing apparatus according to claim 1, wherein the second information is geographical information at a time specified by the user.

3. The information processing apparatus according to claim 1, wherein the second information includes pieces of geographical information at multiple times.

4. The information processing apparatus according to claim 1, wherein the control unit is further configured to, when the specific facility is not included in the first result, transmit the result information including information for providing notification that the specific facility is currently not in existence to a terminal associated with the user.

5. The information processing apparatus according to claim 1, wherein the control unit is further configured to, when the specific facility is not included in the first result, transmit the result information including a location of the specific facility in the second result and information on a facility existing at the location of the specific facility in the second result in the first information to a terminal associated with the user.

6. The information processing apparatus according to claim 4, wherein the control unit is further configured to, when a facility in the same category as the specific facility is in existence within a predetermined first range from a location of the specific facility in the second result, transmit the result information including information on the facility to a terminal associated with the user.

7. The information processing apparatus according to claim 1, wherein:
the location of the specific facility is a destination of the user; and
the control unit is further configured to
generate a second route to the destination based on information on locations of roads at the time, and
generate a first route to the destination based an the second route and information on current locations of roads and notify the user of the first route.

8. The information processing apparatus according to claim 7, wherein the control unit is configured to acquire a point that is in the second route and at which a landmark that is a mark used when the user moves is in existence within a predetermined second range and generate the first route such that the first route passes through the point.

9. The information processing apparatus according to claim 7, wherein the control unit is configured to generate the first route based on a deviation from the second route.

10. An information processing method that is executed by a computer, the information processing method comprising:
searching for a location of a specific facility specified by a user based on first information that is current geographical information including locations of a plurality of facilities;
searching for the location of the specific facility based on second information that is geographical information including locations of a plurality of facilities and that is geographical information at a time prior to a current time; and
generating result information based on a first result that is a search result based on the first information and a second result that is a search result based on the second information and notifying the user of the result information.

11. The information processing method according to claim 10, wherein the second information is geographical information at a time specified by the user.

12. The information processing method according to claim 10, wherein the second information includes pieces of geographical information at multiple times.

13. The information processing method according to claim 10, further comprising, when the specific facility is not included in the first result, transmitting the result information including information for providing notification that the specific facility is currently not in existence to a terminal associated with the user.

14. The information processing method according to claim 10, further comprising, when the specific facility is not included in the first result, transmitting the result information including a location of the specific facility in the second result and information on a facility existing at the location of the specific facility in the second result in the first information to a terminal associated with the user.

15. The information processing method according to claim 13, further comprising, when a facility in the same category as the specific facility is in existence within a predetermined first range from a location of the specific facility in the second result, transmitting the result information including information on the facility to a terminal associated with the user.

16. The information processing method according to claim 10, wherein:
the location of the specific facility is a destination of the user; and
the information processing method further comprises:
generating a second route to the destination based on information on locations of roads of the time; and
generating a first route to the destination based on the second route and information on a current location of a road and notifying the user of the first route.

17. The information processing method according to claim 16, wherein a point that is in the second route and at which a landmark that is a mark used when the user moves is in existence within a predetermined second range is acquired, and the first route is generated such that the first route passes through the point.

18. The information processing method according to claim 16, wherein the first route is generated based on a deviation from the second route.

19. A program for causing a computer to execute instructions comprising:
receiving result information including a location of a specific facility specified by a user based on a search result that is based on first information that is current geographical information including locations of multiple facilities and that is on the location of the specific facility and a search result that is on a location of the specific facility based on second information including locations of multiple facilities at a time prior to a current time; and
based on the result information, displaying the location of the specific facility at the time and displaying information on a current location of the specific facility.

20. The program according to claim 19, wherein the instructions further comprise switching between display of the location of the specific facility at the time and display of the current location of the specific facility based on selection made by the user.
